(19) United States
(12) Patent Application Publication
(10) Pub. No.: US 2020/0053976 A1
(43) Pub. Date: Feb. 20, 2020

(54) Barn Baffle Curtain Assembly

(71) Applicant: Shady Lane Curtains, LLC, Bird-in-Hand, PA (US)

(72) Inventor: Samuel Fisher, Bird-in-Hand, PA (US)

(73) Assignee: Shady Lane Curtains, LLC, Bird-in-Hand, PA (US)

(21) Appl. No.: 16/542,593

(22) Filed: Aug. 16, 2019

Related U.S. Application Data
(60) Provisional application No. 62/764,854, filed on Aug. 16, 2018.

(51) Int. Cl. A01K 1/00; E06B 9/42; E06B 9/34; E06B 9/58

(52) U.S. Cl. CPC A01K 1/007; E06B 9/42; E06B 2009/425; E06B 9/58; E06B 9/34

(57) ABSTRACT

A barn baffle curtain assembly according to the invention is provided. The barn baffle curtain assembly includes a curtain support system and a baffle curtain. The curtain support system includes an upper frame extending between pair of outer walls. The baffle curtain includes an upper panel secured to the upper frame by an upper curtain support, and a lower panel secured to the upper panel. The lower panel includes a first end connected to the upper panel by a middle curtain support and a second end connected to a lower curtain rod, the lower panel pivotable about upper curtain support and the middle curtain support.

### CROSS-REFERENCE TO RELATED APPLICATIONS

This application claims the benefit of the filing date under 35 U.S.C. § 119(e) of Provisional Patent Application No. 62/764,854, filed Aug. 16, 2018.

### FIELD OF THE INVENTION

The invention relates to a barn curtain and, more particularly, to a barn baffle curtain assembly for use in improved ventilation in a livestock barn.

### BACKGROUND

Large free stall barns with high clearance and tunnel ventilation are constantly in search of the best way to keep their livestock comfortable. Proper ventilation in large barn is essential to the health and production of your herd. Therefore, there is a need for curtains inside of large barns to help control airflow and ventilation, and improve the health and production of livestock in the barn.

### SUMMARY

In view of the aforementioned problems, a barn baffle curtain assembly according to the invention is provided. The barn baffle curtain assembly includes a curtain support system and a baffle curtain. The curtain support system includes an upper frame extending between pair of outer walls. The baffle curtain includes an upper panel secured to the upper frame by an upper curtain support, and a lower panel secured to the upper panel. The lower panel includes a first end connected to the upper panel by a middle curtain support and a second end connected to a lower curtain rod, the lower panel pivotable about upper curtain support and the middle curtain support.

### DETAILED DESCRIPTION OF THE DRAWINGS

The invention will now be described by way of example with reference to the accompanying figures, of which:

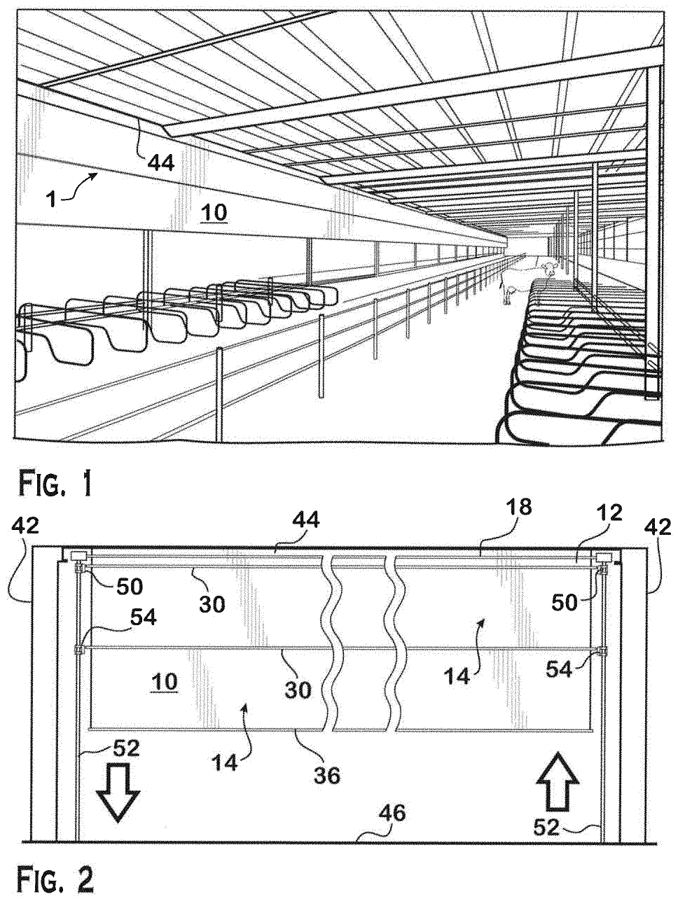

FIG. 1 is a perspective view of a barn baffle curtain assembly according to the invention installed inside of a livestock barn;

FIG. 2 is a front view of a barn baffle curtain assembly according to the invention;

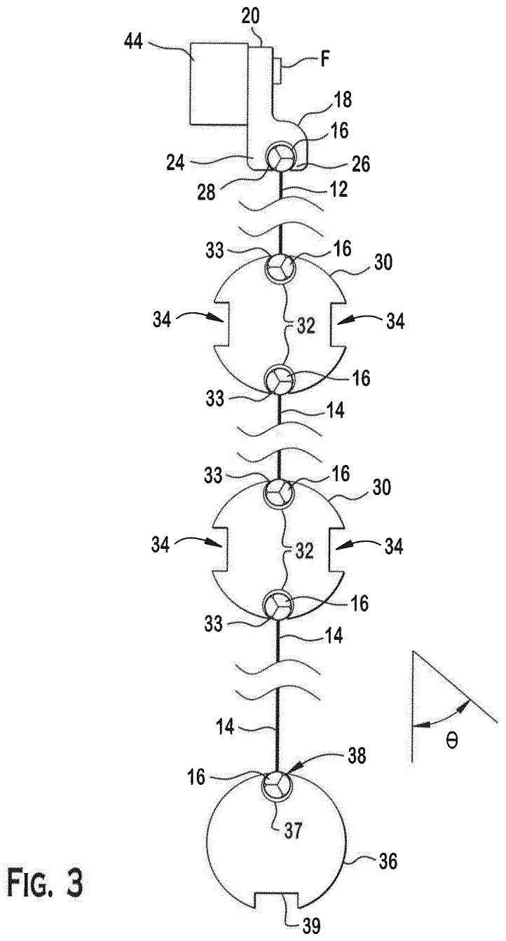

FIG. 3 is a side view of a barn baffle curtain assembly according to the invention;

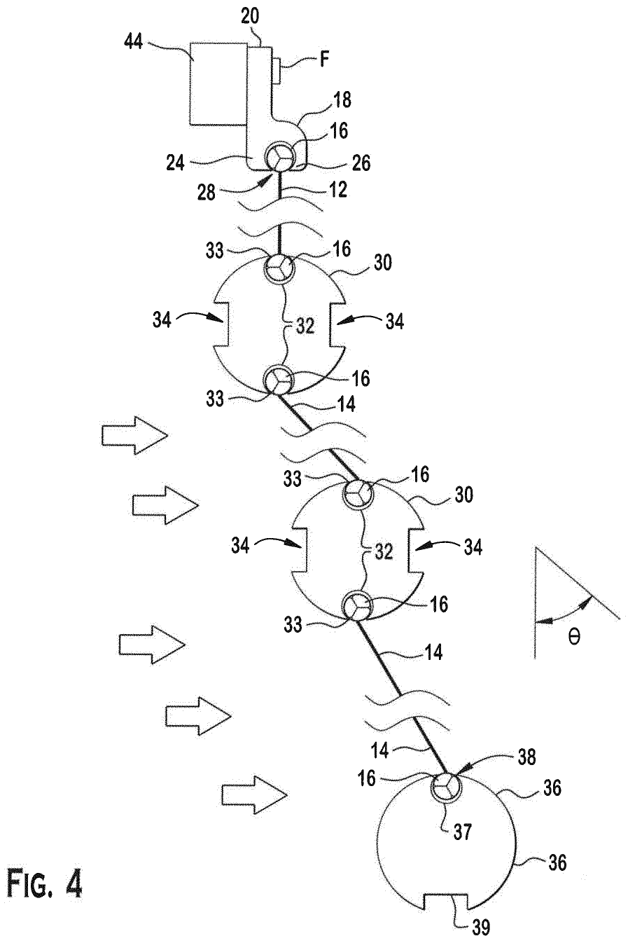

FIG. 4 is another side view of a barn baffle curtain assembly according to the invention, showing the barn baffle curtain assembly being movable with the flow of air;

FIG. 5 is a sectional view of a barn curtain of a barn baffle curtain assembly according to the invention;

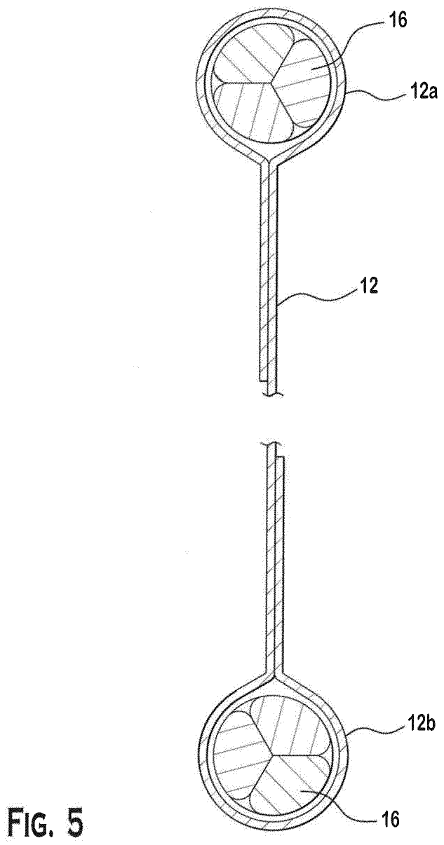

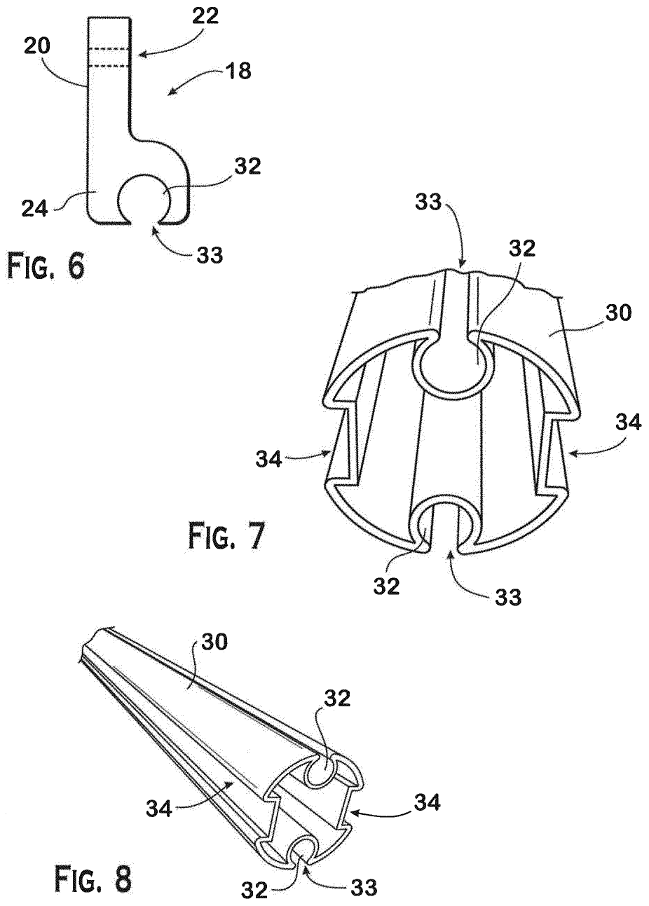

FIG. 6 is a perspective view of an upper curtain support of a barn baffle curtain assembly according to the invention;

FIG. 7 is a perspective view of a middle curtain support of a barn baffle curtain assembly according to the invention;

FIG. 8 is another perspective view of the middle curtain support of FIG. 6;

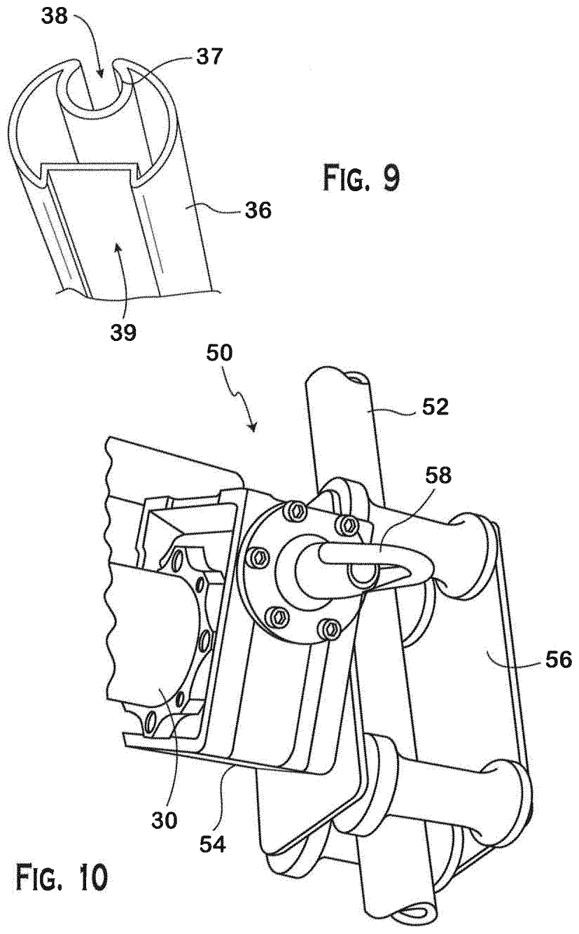

FIG. 9 is a perspective view of a lower curtain rod of a barn baffle curtain assembly according to the invention;

FIG. 10 is a perspective view of a motor assembly of a barn baffle curtain assembly according to the invention;

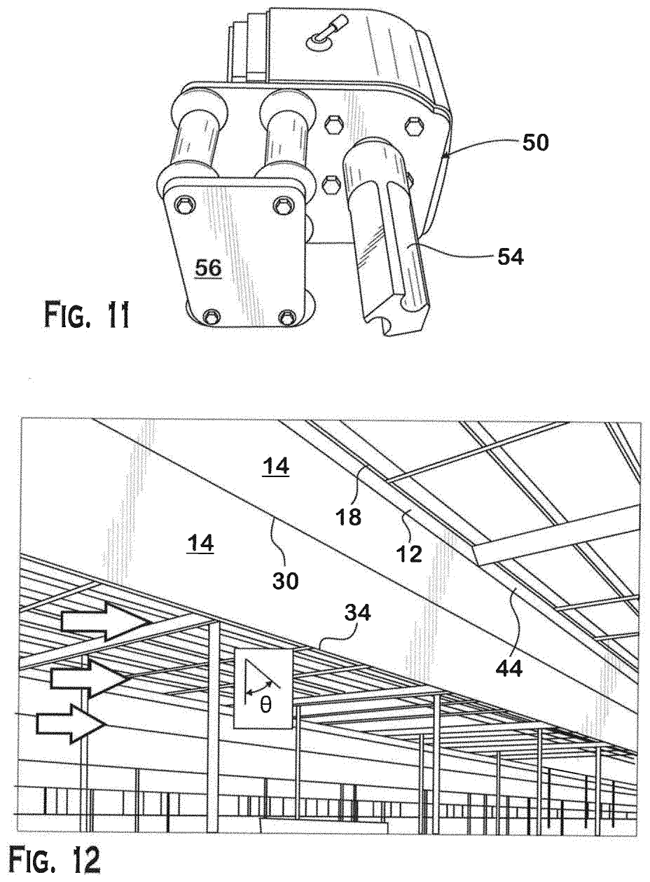

FIG. 11 is another perspective view of the motor assembly of FIG. 9;

FIG. 12 is a perspective view of a barn baffle curtain assembly according to the invention shown diverting air across the top of the barn;

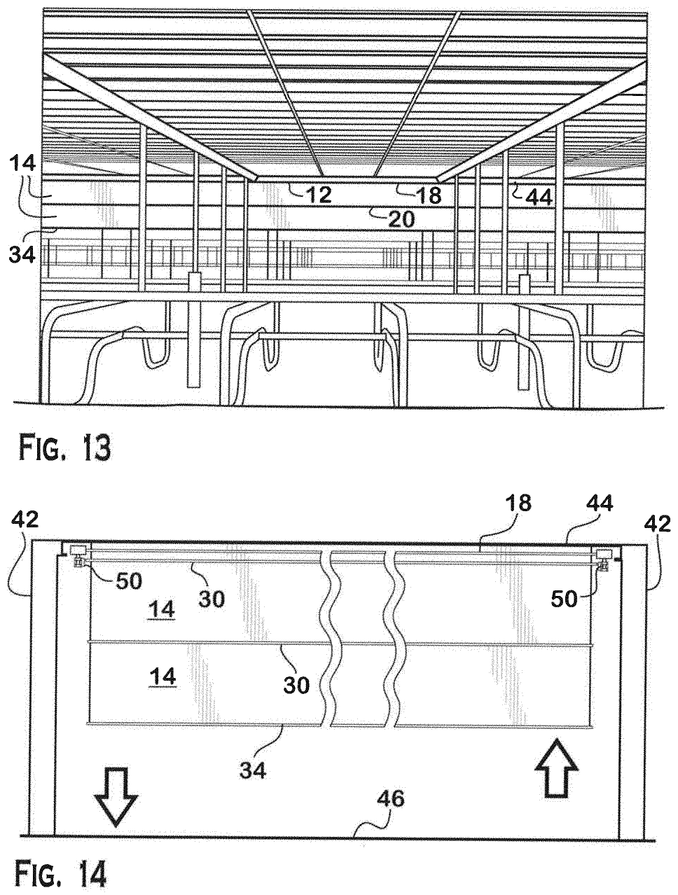

FIG. 13 is a perspective view of a barn baffle curtain assembly according to the invention shown installed inside of a livestock barn; and

FIG. 14 is a front view of another barn baffle curtain assembly according to the invention.

### DETAILED DESCRIPTION OF THE EMBODIMENTS

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein; rather, these embodiments are provided so that the present disclosure will be thorough and complete, and will fully convey the concept of the disclosure to those skilled in the art.

With reference to the accompanying drawings, embodiments of the invention are directed to a barn baffle curtain assembly 1 according to the invention will be described.

With reference to FIGS. 1-13, a barn baffle curtain assembly 1 according to the invention is shown. The barn baffle curtain assembly 1 generally includes the following major components: a baffle curtain 10, a curtain support system 40, and a retraction system 50.

As shown in FIGS. 2 through 4, the baffle curtain 10 includes an upper panel 12 and at least one lower panel 14 attached to the upper panel 12. In the shown embodiment, the baffle curtain 10 includes an upper panel 12 secured to the livestock structure (i.e. upper frame a beam or pole extending across a length of the barn) using an upper frame 44 and a plurality of lower panels 14 connected to each other using middle curtain supports 30. The lowest lower panel 14 is connected to a lower curtain support 36. As shown in FIGS. 1 and 2, the upper panel 12 is in a retracted position.

Many suitable materials for the upper panel 12 and the lower panel 14 are known and available. In an exemplary embodiment, the upper panel 12 and the lower panel 14 are comprised of materials sufficiently strong and flexible to allow the baffle curtain 10 to be rolled into a cylindrical shape without cracking or fracturing as conditions warrant. The material chosen for the panels 12, 14 may additionally be abrasion-resistant, weatherable, and dimensionally stable. Furthermore, the material should not be breathable, as air should not easily pass there through.

Each panel 12, 14 is a sheet of plastic film or fabric material. In the shown embodiment, each panel 12, 14 is opaque. However, one skilled in the art should appreciate that each panel 12, 14 could also be a transparent or translucent material which transmits light there through.

With reference to FIG. 5, an exemplary lower panel 14 is shown. One skilled in the art should appreciate that the same design can be performed for the upper panel 12 as well. For sake of brevity, this description will focus on the exemplary embodiment shown in FIG. 5.

As shown, the lower panel 14 includes an upper support receiving passageway 14a and a lower support receiving passageway 14b. The upper support receiving passageway 14a, as described in greater detail below, is formed by looping and joining an upper side of the lower panel 14. The lower support receiving passageway 14b is similarly formed by looping and joining 20 a lower side of the lower panel 14. Both the upper support receiving passageway 14a and the lower support receiving passageway 14b are tubular passageways in the shown embodiment and secured by a weld that are sized to receive cord 16 there through and is used as a support for the baffle curtain 10.

One skilled in the art should appreciate that the same design can be performed for the upper panel 12 as well. For sake of brevity, the description focused on the exemplary embodiment shown in FIG. 5, and it is understood that the upper support receiving passageway 12a and the lower support receiving passageway 12b similar to what is described above.

With reference to FIG. 6, an upper curtain support 18 according to the invention is shown. In an exemplary embodiment, the upper curtain support 18 generally includes a curtain support section 20 and a fixture attachment section 24. In an exemplary embodiment, the upper curtain support 18 is an elongated monolithic member having an h-shape. The upper curtain support 18 may be formed from a strong rigid material such as aluminum. The curtain support section 20 is a planar member having a pair of opposing planar surfaces 20a, 20b and a fastener receiving passageways 22 extending transverse there through. The fixture attachment section 24 is an elongated body having a retention end receiving passageway 26 extending along a length there through and a curtain receiving passageway 28 extending outward from the retention end receiving passageway 26.

With reference to FIGS. 7 and 8, a middle curtain support 30 according to the invention is shown. In an exemplary embodiment, the middle curtain support 30 is an elongated monolithic tubular member. The middle curtain support 30 generally includes a plurality of retention end receiving passageways 32 formed on opposite sides of the middle curtain support 30. Each retention end receiving passageways 32 is a circular receiving passageway extending along a surface of the middle curtain support 30 and having a curtain receiving passageway 33 extending outward therefrom. In an exemplary embodiment, the middle curtain support 30 includes a pair of retention end receiving passageways 32 positioned on opposite sides of the middle curtain support. Each retention end receiving passageways 32 extends along a length of two side of the middle curtain support 30. As shown, the middle curtain support 30 may include one or more motor assembly grooves 34 positioned on an outer surface thereof. Each motor assembly grooves 34 extends along a length of the middle curtain support 30 and are positioned on adjacent sides to the plurality of retention end receiving passageways 32 formed on opposite sides of the middle curtain support 30.

With reference to FIG. 9, a lower curtain support 36 according to the invention is shown. In an exemplary embodiment, the lower curtain support 36 is an elongated monolithic tubular member. The lower curtain support 36 generally includes a retention end receiving passageways 37 formed on top side thereof. The retention end receiving passageways 37 is a circular receiving passageway extending along a top surface of the lower curtain support 36 and having a curtain receiving passageway 38 extending outward therefrom. As shown, the lower curtain support 36 may also include a motor assembly grooves 39 positioned on an outer surface thereof and opposite the retention end receiving passageways 37. The motor assembly grooves 39 extends along a length of the lower curtain support 36.

With reference to FIGS. 2 through 4, assembly of the baffle curtain 10 will be described.

As shown in FIGS. 2 through 5, a top section of an upper panel 12 is secured to the upper curtain support 18 and, more particularly, to the fixture attachment section 24. The an upper support receiving passageway 12a is positioned through the fixture attachment section 24 and the sheet extends through the curtain receiving passageway 28 extending outward from the retention end receiving passageway 26. A lower section of the upper panel 12 is then secured to a first middle curtain support 30 by feeding the lower support receiving passageway 12b through one of the plurality of retention end receiving passageways 32 formed on opposite sides of the first middle curtain support 30.

Next, a top section of a first lower panel 14 is secured to the first middle curtain support 30 and, more particularly, to the other retention end receiving passageways 32 formed opposite to the retention end receiving passageways 32 secured to the upper panel 12. Specifically, the first lower panel 14 is secured to the first middle curtain support 30 by feeding the lower support receiving passageway 14b through one of the plurality of retention end receiving passageways 32 formed on an opposite side of the retention end receiving passageways 32 receiving the first middle curtain support 30. A lower section of the first lower panel 14 is then secured to a second middle curtain support 30 by feeding the lower support receiving passageway 14b through one of the plurality of retention end receiving passageways 32 formed on opposite sides of the second middle curtain support 30.

Next, a top section of a second lower panel 14 is secured to the second middle curtain support 30 and, more particularly, to the other retention end receiving passageways 32 formed opposite to the retention end receiving passageways 32 secured to the first lower panel 14. Specifically, the second lower panel 14 is secured to the second middle curtain support 30 by feeding the lower support receiving passageway 14b through one of the plurality of retention end receiving passageways 32 formed on an opposite side of the retention end receiving passageways 32 receiving the first lower panel 14.

Next, a bottom section of a second lower panel 14 is secured to the lower curtain support 36 and, more particularly, to the retention end receiving passageways 37. Specifically, the second lower panel 14 is secured to the lower curtain support 36 by feeding the lower support receiving passageway 14b through the retention end receiving passageways 37.

Now with reference to FIG. 2-4, the curtain support system 40 will be described.

As shown, the curtain support system 40, in the least, a pair of outer walls 42 and an upper frame 44, and a floor 46. A curtain receiving space 48 is provided between the pair of outer walls 42, the upper frame 44, and the floor 46.

Since livestock structures can be of such a size that the structures may include a plurality of window framings 41 formed along the curtain receiving space 48 between the upper frame 44 and the floor 46. These window framings 41 allow the passage of air to ventilate the structures. Fans (not shown) may also be included in the livestock structure to promote airflow there across.

Now with reference to FIGS. 2, 10, and 11, a retraction system 50 for the barn baffle curtain assembly 1 will be described.

While an embodiment is shown, the retraction system 50 is used to roll and unroll one or more lower panels 14 and any known hoisting system known to the art would be sufficient.

In the shown embodiment, the retraction system 50 includes a pair of outer support rods 52, and a lifting mechanism 54.

As shown in the Figures, each outer support rod 52 is a structural member, such a pole, positioned along and fixed to the upper frame 44. In the shown embodiment, each outer support rod 52 is tubular and secured to the upper frame 44 using a bracket or similar known device.

The lifting mechanism 54 may be a winch, or the like, such as a windlass, for raising and lowering the baffle curtain 10.

In exemplary embodiments of the invention, the lifting mechanism 54 generally includes a winding device 58 and a pair of rolling mechanisms 56 having a set of rollers positioned around and corresponding to the pair of outer support rods 52. Each rolling mechanisms 56 is free to move up and down the pair of outer support rods 52. The winding device 58 is connected to one of the rolling mechanisms 56, along one side of the pair of outer support rods 52. In the shown embodiment, the rolling mechanisms 56 is a roll-up mechanism, that is, a device for winding up the lower panel 14 using the middle curtain support 30. Middle curtain support 30 is connected to the winding device 58, so as to rotate when the winding device is rotated, for instance, using the roll-up mechanism. This can be performed with a keyed interface of the winding device that matches the one or more motor assembly grooves 34 positioned on an outer surface thereof. As shown, the winding device may be a hand-cranked (see FIG. 10) or electrically or pneumatically operated (see FIG. 11) assembly. In the shown embodiment, the lifting mechanism 54 includes pair of rolling mechanisms 56 having a set of rollers positioned around and corresponding to the pair of outer support rods 52. Each rolling mechanisms 56 is free to move up and down the pair of outer support rods 52.

In an alternative embodiment, as shown in FIG. 14, the lifting mechanism 54 may only include a winding device 58 and the pair of rolling mechanisms 56 are removed in order to promote movement of the lower panel 14.

Now with reference to FIGS. 1-4, assembly of the barn baffle curtain assembly 1 according to the invention will be described. The baffle curtain 10 connects to the curtain support system 40 such that the baffle curtain hangs from the upper frame 44 which supported by the pair of outer walls 42. As shown in FIGS. 3 and 4, the baffle curtain 10 is secured to the upper frame 44 by fasteners F extending through the upper curtain support 18. The lower curtain support 36 is then suspended above the floor 46 in the curtain receiving space 48. The retraction system 50 is then secured to each of the middle curtain supports 30 such that the lifting mechanism 54 winds the lower panels 14 about the middle curtain supports 30 to raise the lower curtain support 36 above the floor 46.

As air flows through the livestock structure, the air can be diverted by the barn baffle curtain assembly 1 by lowering and raising the baffle curtain 10. Since the baffle curtain 10 is suspended by the upper frame 44, the baffle curtain 10 can sway to facilitate natural air flow across the livestock structure.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A barn baffle curtain assembly, comprising:
a curtain support system having an upper frame extending between pair of outer walls; and
a baffle curtain having:
an upper panel secured to the upper frame by an upper curtain support; and
a lower panel having a first end connected to the upper panel by a middle curtain support and a second end connected to a lower curtain rod, the lower panel pivotable with respect to the upper curtain support and the middle curtain support.

2. The barn baffle curtain assembly of claim 1, wherein the upper panel is pivotable with respect to the curtain support system.

3. The barn baffle curtain assembly of claim 2, wherein the upper panel is less pivotable than the first lower panel with respect to the curtain support system.

4. The barn baffle curtain assembly of claim 3, wherein the lower panel includes a pair of panel sections connected by a second middle curtain support, the pair of panel sections having a first panel connected to the lower curtain rod and a second panel connected to the second lower curtain rod, the second panel more pivotable with respect to middle curtain support than the first panel.

5. The barn baffle curtain assembly of claim 4, wherein the upper panel is a sheet of plastic film or fabric material.

6. The barn baffle curtain assembly of claim 5, wherein the lower panel is a sheet of plastic film or fabric material.

7. The barn baffle curtain assembly of claim 4, wherein the upper curtain support includes a curtain support section secured to the upper frame and a fixture attachment section having a retention end receiving passageway extending along a length there through and a curtain receiving passageway extending outward from the retention end receiving passageway, the upper panel extending through the curtain receiving passageway and into the retention end receiving passageway.

8. The barn baffle curtain assembly of claim 7, wherein the upper curtain support is an elongated monolithic member having an h-shape.

9. The barn baffle curtain assembly of claim 7, wherein the middle curtain support is an elongated monolithic tubular member.

10. The barn baffle curtain assembly of claim 9, wherein the middle curtain support includes a plurality of retention end receiving passageways formed on opposite sides thereof, each retention end receiving passageways is a circular receiving passageway extending along a surface of the middle curtain support and having a curtain receiving passageway extending outward therefrom.

11. The barn baffle curtain assembly of claim 10, wherein the middle curtain support further includes a pair of motor assembly grooves positioned on outer surfaces thereof, each motor assembly groove extends along a length of the middle curtain support and are positioned on adjacent sides to the plurality of retention end receiving passageways formed on opposite sides of the middle curtain support.

12. The barn baffle curtain assembly of claim 10, wherein the lower curtain support is an elongated monolithic tubular member.

13. The barn baffle curtain assembly of claim 12, wherein the lower curtain support includes a retention end receiving passageway formed on top side thereof.

14. The barn baffle curtain assembly of claim 13, wherein the retention end receiving passageways is a circular receiving passageway extending along a top surface of the lower curtain support and having a curtain receiving passageway extending outward therefrom.

15. The barn baffle curtain assembly of claim 14, wherein the upper panel includes an upper support receiving passageway securing cord there through that is secured in the retention end receiving passageway of the upper curtain support.

16. The barn baffle curtain assembly of claim 15, wherein the upper panel includes a lower support receiving passageway securing cord there through that is secured to a first retention end receiving passageway of the pair of retention end receiving passageways of middle curtain support.

17. The barn baffle curtain assembly of claim 16, wherein the lower panel includes an upper support receiving passageway securing cord there through that is secured to a second retention end receiving passageway of the pair of retention end receiving passageways of middle curtain support.

18. The barn baffle curtain assembly of claim 17, wherein the lower panel includes a lower support receiving passageway securing cord there through that is secured to the retention end receiving passageway of the lower curtain support.

19. The barn baffle curtain assembly of claim 18, further comprising a retraction system to roll and unroll the lower panel.

20. The barn baffle curtain assembly of claim 19, wherein the retraction system includes a pair of outer support rods and a lifting mechanism.

21. The barn baffle curtain assembly of claim 20, wherein each outer support rod of the pair of support rods is a structural member fixed to the upper frame.

22. The barn baffle curtain assembly of claim 21, wherein the lifting mechanism is a winch.

23. The barn baffle curtain assembly of claim 21, wherein the lifting mechanism includes a winding device and a pair of rolling mechanisms having a set of rollers positioned around and corresponding to the pair of outer support rods.
